(19) United States
(12) Patent Application Publication
(10) Pub. No.: US 2012/0188289 A1
(43) Pub. Date: Jul. 26, 2012

(54) PROJECTOR WITH LUMINANCE ADJUSTING FUNCTION AND METHOD THEREOF

(75) Inventor: HUANG-NIEN LIN, Tu-Cheng (TW)

(73) Assignee: HON HAI PRECISION INDUSTRY CO., LTD., Tu-Cheng (TW)

(21) Appl. No.: 13/163,723

(22) Filed: Jun. 19, 2011

(30) Foreign Application Priority Data
Jan. 21, 2011 (CN) 201110023821.3

(51) Int. Cl. G09G 5/10

(52) U.S. Cl. 345/690

(57) ABSTRACT

A projector with a luminance adjusting function is provided. The projector projects images to a projective plane. The projector stores a color adjusting table. The color adjusting table records a number of modes of the projector and a fine luminance value preset for each mode of the projector. The projector controls a distance detecting unit to obtain a distance between the projector and the projective plane and controls a color sensor to obtain the color of the projective plane periodically or according to operations of user. The projector determines a current mode of the projector according to the obtained distance and the color and obtains the fine luminance value of the current mode of the projector, and adjusts the luminance of the projector according to the obtained fine luminance value.

### BACKGROUND

1. Technical Field

The present disclosure relates to a projector with an luminance adjusting function and a method thereof.

2. Description of Related Art

When a projector is far away from a projective plane or a color on the projective plane of the projector is light, the luminance of the projector needs to be adjusted for fine-tuning the projecting effect. However, generally, the luminance of the projector is adjusted manually. Thus, the luminance of the projector needs to be adjusted manually for every use, which is inconvenient.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of a projector with an luminance adjusting function in accordance with an exemplary embodiment.

FIG. 2 is a flowchart of a method for adjusting luminance of projector of FIG. 1 in accordance with an exemplary embodiment.

### DETAILED DESCRIPTION

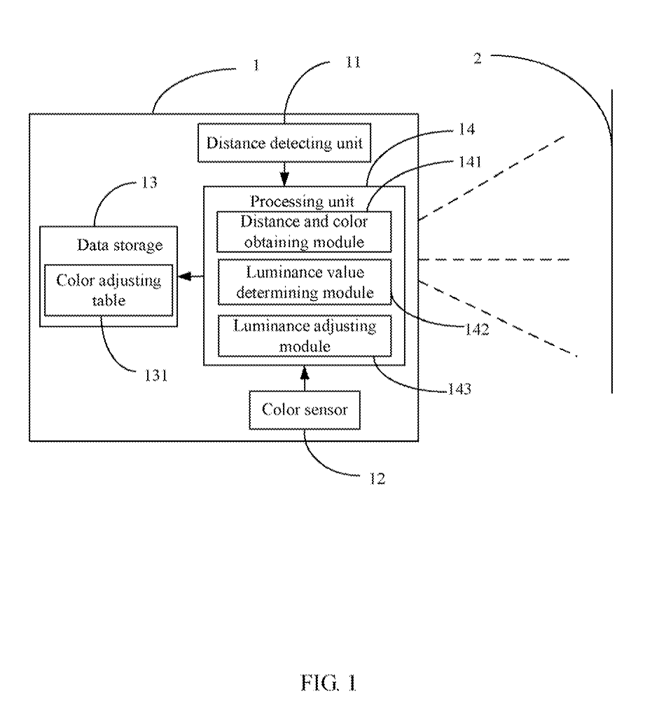

FIG. 1 is a block diagram of a projector 1 with a luminance adjusting function in accordance with an exemplary embodiment. The projector 1 is capable of projecting images to a projective plane 2. The projective plane 2 can be a wall, or a screen. The projector 1 includes a distance detecting unit 11, a color sensor 12, a data storage 13, and a processing unit 14. The distance detecting unit 11 is configured for detecting a distance between the projector 1 and the projective plane 2. The color sensor 12 is configured for sensing a color of the projective plane 2. The color of the projective plane is background of the projective plane 2. If the projective plane 2 is a white wall, the color of the projective plane is white. In the present embodiment, the distance detecting unit 11 is an infrared distance detector. The color sensor 12 is a CMOS color sensor.

The data storage 13 stores a color adjusting table 131, as shown in table 1 below. In the present embodiment, the projector 1 includes a number of modes. Each mode of the projector is preset with a fine luminance value. The modes of the projector 1 are set according to the distance between the projector 1 and the projective plane 2 and the color of the projective plane 2. For example, as shown in Table 1, if the distance between the projector 1 and the projective plane 2 falls in a range <=1 M, and the color of the projective plane 2 is white, the projector 1 is defined in a first mode, and the fine luminance value sets for the first mode is 70%. If the distance between the projector 1 and the projective plane 2 falls in a range <=1 M, the color of the projective plane 2 is black, the projector 1 is defined in a second mode, and the fine luminance value sets for the second mode is 35%. If the distance between the projector 1 and the projective plane 2 falls in a range >1 M, the color of the projective plane 2 is white, the projector 1 is defined in a fourth mode, and the fine luminance value sets for the fourth mode is 100%.

| | | | Luminance |
|---|---|---|---|
| Mode | Distance | Color | value |
| First | <=1M | White | 70% |
| Second | <=1M | Black | 35% |
| Third | <=1M | Other colors | 55% |
| Fourth | >1M | White | 100% |
| Fifth | >1M | Black | 50% |
| Sixth | >1M | Other colors | 80% |

The processing unit 14 includes a distance and color obtaining module 141, an luminance value determining module 142, and an luminance adjusting module 143. The distance and color obtaining module 141 controls the distance detecting unit 11 to obtain the distance between the projector 1 and the projective plane 2, and controls the color sensor 12 to obtain the color of the projective plane 2 periodically or according to operations of user. The luminance value determining module 142 is for determining a current mode of the projector 1 according to the obtained distance and the color and obtaining the fine luminance value of the current mode of the projector 1 from the color adjusting table 131. The luminance adjusting module 143 is for adjusting the luminance of the projector 1 according to the obtained fine luminance value of the current mode.

For example, if the distance between the projector 1 and the projective plane 2 detected by the distance detecting unit 11 is 1.5 m, the color of the projective plane 2 is red. The luminance value determining module 142 determines that the current mode of the projector 1 is the sixth mode, and obtains the fine luminance value 80% corresponding to the sixth mode. The luminance adjusting module 143 adjusts the luminance of the projector 1 to 80%.

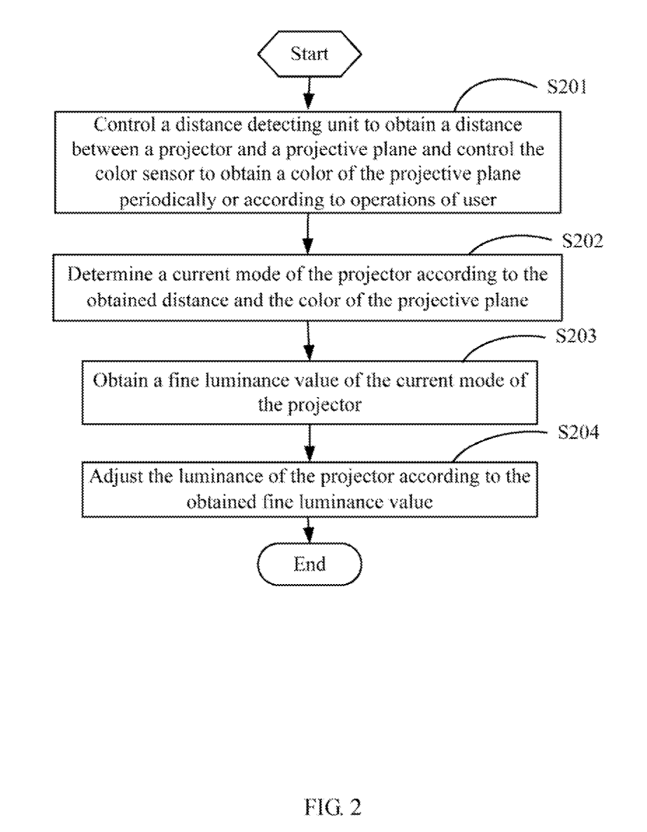

FIG. 2 is a flowchart of a method for adjusting luminance of projector 1 of FIG. 1. In step S201, the distance and color obtaining module 141 controls the distance detecting unit 11 to obtain the distance between the projector 1 and the projective plane 2, and controls the color sensor 12 to obtain the color of the projective plane 2 periodically or according to operations of user.

In step S202, the luminance value determining module 142 determines a current mode of the projector 1 according to the obtained distance and the color of the projective plane.

In step S203, the luminance value determining module 142 obtains the fine luminance value of the current mode of the projector 1 from the color adjusting table 131.

In step S204, the luminance adjusting module 143 adjusts the luminance of the projector 1 according to the obtained fine luminance value of the current mode.

Although, the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. A projector for projecting images to a projective plane, comprising:
a data storage for storing a color adjusting table, the color adjusting table recording a plurality of modes of the projector and a fine luminance value preset for each of the modes of the projector, the plurality of modes of the projector being set according to a distance between the projector and the projective plane and the color of the projective plane;
a distance detecting unit for detecting a distance between the projector and the projective plane;
a color sensor for sensing a color of the projective plane; and
a processing unit comprising:
a distance and color obtaining module for controlling the distance detecting unit to obtain the distance between the projector and the projective plane and controlling the color sensor to obtain the color of the projective plane periodically or according to operations of user;
a luminance value determining module for determining a current mode of the projector according to the obtained distance and the color and obtaining the fine luminance value of the current mode of the projector from the color adjusting table; and
a luminance adjusting module for adjusting the luminance of the projector according to the obtained fine luminance value.

2. The projector as described in claim 1, wherein the distance detecting unit is an infrared distance detector.

3. The projector as described in claim 1, wherein the color sensor is a CMOS color sensor.

4. A method for adjusting luminance of a projector projecting images to a projective plane, comprising:
presetting a plurality of modes for the projector and presetting a fine luminance for each of the modes of the projector, wherein the plurality of modes of the projector is set according to a distance between the projector and the projective plane and a color of the projective plane;
controlling a distance detecting unit to obtain the distance between the projector and the projective plane and controlling a color sensor to obtain the color of the projective plane periodically or according to operations of user;
determining a current mode of the projector according to the obtained distance and the color and obtaining the fine luminance value of the current mode of the projector;
adjusting the luminance of the projector according to the obtained fine luminance value.

5. The method as described in claim 4, wherein the distance detecting unit 11 is an infrared distance detector.

6. The method as described in claim 4, wherein the color sensor is a CMOS color sensor.
